(19) United States
(12) Patent Application Publication
(10) Pub. No.: US 2021/0206284 A1
(43) Pub. Date: Jul. 8, 2021

(54) CHARGING STATION WITH AUTOMATIC GRID IDENTIFICATION AND METHOD FOR THE CONTROL THEREOF

(71) Applicants: Srdan Skrbic, Dortmund (DE); Christian Lewandowski, Unna (DE)

(72) Inventors: Srdan Skrbic, Dortmund (DE); Christian Lewandowski, Unna (DE)

(73) Assignee: innogy SE, Essen (DE)

(21) Appl. No.: 17/211,685

(22) Filed: Mar. 24, 2021

Related U.S. Application Data
(63) Continuation of application No. PCT/EP2019/074956, filed on Sep. 18, 2019.

(30) Foreign Application Priority Data
Sep. 25, 2018 (DE) 102018123612.3

(51) Int. Cl. B60L 53/60; H02J 13/00; B60L 53/30

(52) U.S. Cl. CPC B60L 53/60; H02J 13/00002; B60L 53/18; H02J 2310/48; B60L 53/30

(57) ABSTRACT

A charging station for providing electrical power to charge an electrically operable vehicle, comprising a grid-side multi-wire power connection for connecting the charging station to a distribution grid and comprising a control device for controlling the charging station, wherein the control device is configured to identify, by means of a grid analysis, a distribution grid connected to the grid-side multi-wire power connection. The invention also relates to a method for controlling the charging station, in which a grid analysis of a distribution grid connected to the grid-side multi-wire power connection of the charging station is carried out and in which the connected distribution grid is identified on the basis of the grid analysis.

### CROSS-REFERENCE TO RELATED PATENT APPLICATIONS

This patent application is a continuation of International Application No. PCT/EP2019/074956, filed on Sep. 18, 2019, which claims the benefit of priority to German Patent Application No. 10 2018 123 612.3, filed Sep. 25, 2018, the entire teachings and disclosures of both applications are incorporated herein by reference thereto.

### FIELD OF INVENTION

The invention relates to a charging station for providing electrical power to charge an electrically operable vehicle, comprising a grid-side multi-wire power connection for connecting the charging station to a distribution grid and comprising a control device for controlling the charging station. The invention also relates to a method for controlling such a charging station.

### BACKGROUND

Charging stations must meet country-specific requirements for different markets in accordance with the respective location of use. On the one hand, different countries have different types of distribution grids, which differ for example in their phase number, in their voltage, their frequency or phase shift. On the other hand, different requirements apply in different countries or distribution grids, which must be adhered to by charging stations connected to the respective distribution grid. The requirements may for example be grid-related requirements, such as for example the maximum permissible power extraction, the maximum permissible current strength per phase, specifications for the reactive power etc. Furthermore, the requirements may be charging station-related requirements, such as for example voltage or current specifications for the charging current by means of which an electric vehicle connected to the charging station is charged.

Up to now, these grid- or charging station-related specifications have been taken into account when manufacturing the charging stations by the hardware and software of a charging station being adapted specifically for the specifications at the planned location of use of the charging station. Therefore, the charging stations have been manufactured specifically for the respective country of use or distribution grid to be used such that different charging station types exist, for example one or a plurality of charging station types for the European market, one or a plurality of charging station types for the Japanese market, one or a plurality of charging station types for the US market, etc.

The variety of different charging station types matched to the respective location of use complicates not only their manufacture, but also subsequent processes, such as for example the storage, marketing, commissioning, maintenance or spares inventory which must be kept separate for the individual charging station types.

### BRIEF SUMMARY

Against this background, the object underlying the present invention is to reduce the complexity resulting from the different country or distribution grid-specific specifications when manufacturing, distributing and maintaining charging poles.

For a charging station for providing electrical power to charge an electrically operable vehicle, comprising a grid-side multi-wire power connection for connecting the charging station to a distribution grid and comprising a control device for controlling the charging station, this object is achieved according to the invention in that the control device of the charging station is configured to identify, by means of a grid analysis, a distribution grid connected to the grid-side multi-wire power connection.

Furthermore, the aforementioned object is achieved according to the invention by a method for controlling the previously described charging station, in which a grid analysis of a distribution grid connected to the grid-side multi-wire power connection of the charging station is carried out and in which the connected distribution grid is identified on the basis of the grid analysis.

The charging station is therefore capable of automatically identifying the distribution grid to which the charging is connected. As a result, a presetting of the distribution grid, to which the charging station is intended to be connected, is unnecessary. This enables a standard charging station to be used even for different distribution grids or for different countries since the charging station itself is capable of identifying which distribution grid it is connected to.

Preferably, the charging station can configure itself in this manner as a function of the identified distribution grid in order to meet the requirements existing in the respective distribution grid. Accordingly, the control device is preferably configured to control, in particular to configure, the charging station as a function of the identified distribution grid. In the case of a corresponding embodiment of the method, the charging station is controlled, in particular configured, as a function of the identified distribution grid. In this manner, one charging station type can be used for different countries such that, for example for the European and US market, only one charging station type has to be produced, stored and maintained.

By controlling, in particular configuring, the charging station as a function of the identified distribution grid, the charging station can be automatically set by the control device for the correct distribution grid to which it is connected. If the control device identifies the distribution grid connected to the multi-wire power connection for example as a US distribution grid, then the control device can configure the charging station such that it meets the specifications for charging stations in US distribution grids.

The charging station serves to provide electrical power to charge an electrically operable vehicle. The charging station can in particular be a charging pole or what is known as a wall box. In order to provide electrical power to charge an electrically operable vehicle, the charging station has in particular a charging connection. The charging connection can for example be a charging outlet to plug in a charging cable in order to be able to connect the charging station to an electrically operable vehicle. The charging station can also have a fixedly installed charging cable which can be connected to an electrically operable vehicle.

The charging station has a grid-side multi-wire power connection to connect the charging station to a distribution grid. The distribution grid may in particular be a low-voltage grid.

Different distribution grids have a different number of lines. Thus, for example, a rotary current distribution grid in Germany typically has five wires at the connection location, namely three wires for the three phases L1, L2 and L3, one wire for the neutral wire N and one wire for the protective wire PE. In Italy, Spain and France and also in some regionally limited areas in Germany, the rotary current distribution grid at the connection location, in contrast, has only four wires, namely three wires for the three phases L1, L2 and L3 and one wire for the neutral wire N. In the US, distribution grids with three wires for three phases are common or also distribution grids with four wires, which have an additional wire for the neutral wire.

Similarly, distribution grids also allow for different connection types, in which in part not all wires of the distribution grid are connected. In the German rotary current distribution grid with five wires, in addition to the connection of all three phases, a single-phase connection type is namely also possible, in which only one of the three phases is connected. This connection type therefore requires three wires, namely one phase wire, one neutral wire and one protective wire.

The multi-wire power connection is in particular a multi-phase power connection, which enables the connection of a plurality of phases and, if necessary, additional neutral and/or protective wires. Furthermore, the grid-side multi-wire power connection preferably enables the connection of at least five, in particular exactly five wires. In this manner, practically all distribution grids or connection types of the distribution grids used in practice can be connected to the multi-wire power connection, whereby in the case of some distribution grids and connection types not every connection of the multi-wire power connection has to be connected.

Different embodiments of the charging station and of the method are described below, whereby the individual embodiments are applicable independently of one another to both the charging station and the method. The individual embodiments are also combinable with one another.

In one embodiment, the configuration of the charging station comprises the setting of operational specifications to operate the charging station, in particular grid-related and/or charging process-related operational specifications, as a function of the identified distribution grid. In the case of a corresponding embodiment, when configuring the charging station, operational specifications for operating the charging station, in particular grid-related and/or charging process-related operational specifications are set as a function of the identified distribution grid.

The grid-related operational specifications may in particular be one or a plurality of the following operational specifications: maximum current strength per phase, maximum power that can be extracted from the distribution grid, maximum permissible reactive power. The charging process-related operational specifications may in particular be one or a plurality of the following operational specifications: minimum charging current strength, maximum charging current strength, minimum charging voltage, maximum charging voltage.

In this manner, operational specifications of determined distribution grids or region- or country-specific operational specifications for the charging process can be automatically adapted to the detected distribution grid such that a manual configuration of the charging station is not required.

The configuration can, additionally or alternatively, also include operational specifications for billing and/or consumption measurement during the charging process as a function of the identified distribution grid. Additionally or alternatively, the configuration of the charging station can also contain operational specifications for setting the language on a display of the charging station or of a currency for the internal billing or to be displayed on a display. In this manner, for example even the language and/or the currency can be automatically adapted to the country in which the identified distribution grid is located.

In a further embodiment, the control device is configured to cause, for the grid analysis, the determination, in particular the measurement, of one or a plurality of electrical characteristic values of the distribution grid connected to the grid-side multi-wire power connection. In a corresponding embodiment, for the grid analysis, one or a plurality of electrical characteristic values of the distribution grid connected to the grid-side multi-wire power connection are determined, in particular measured. The determined or in particular measured electrical characteristic values include in particular one or a plurality of the following characteristic values: number of the connected wires, number of the connected phases, frequency of the distribution grid, effective value of the voltage, phase angle, voltages of the individual connected wire in relation to one another.

The distribution grids used worldwide differ in their respective combination of electrical grid characteristic values, for example in regard to the number of the phases, the frequency, the voltage, etc., and can in this manner be distinguished from one another or identified. In order to determine, in particular to measure, the aforementioned characteristic values, the charging station comprises in particular corresponding measuring means or measuring devices, with which the voltage, the frequency, the phase shift and the like can be detected.

In a further embodiment, the control device is configured, for the identification of the distribution grid connected to the grid-side multi-wire power connection, to compare the determined electrical characteristic values with predefined grid characteristic values. In a corresponding embodiment of the method, for identifying the distribution grid connected to the grid-side multi-wire power connection, the determined electrical characteristic values are compared with predefined grid characteristic values. By comparing with the predefined characteristic values of different distribution grids, an automatic identification of the connected distribution grid can be carried out through the grid analysis.

Preferably, respective grid characteristic values for a plurality of predefined distribution grids are stored on a data memory of the charging station and the control device is configured to compare the determined electrical characteristic values with the stored grid characteristic values and to identify the distribution grid connected to the grid-side multi-wire power connection as a function of the result of the comparison as one of the plurality of predefined distribution grids. In a corresponding embodiment of the method, respective grid characteristic values for a plurality of predefined distribution grids are stored on a data memory of the charging station and the determined electrical characteristic values are compared with the stored grid characteristic values and the distribution grid connected to the grid-side multi-wire power connection is identified as one of the plurality of predefined distribution grids as a function of the result of the comparison.

Grid characteristic values from different regions, in particular different countries, with different specifications for the grid connection of a charging station or for the operation of a charging station can be included in the data memory. In this way, the charging station can determine the region or the country in which it has been installed in a distribution grid and, as a result, it can automatically take region- or country-specific operational specifications into account. Grid characteristic values for different connection types in a distribution grid can in particular also be stored on the data memory, for example grid characteristic values for a three-phase or for a single-phase connection in the European rotary current grid. In this manner, the charging station can identify the distribution grid irrespective of the connection type specifically selected by the installer.

The grid characteristic values respectively assigned in a distribution grid include in particular values for one or a plurality, preferably all of the following grid parameters: number of wires of the distribution grid or the connection type in question, number of the phases of the distribution grid or the connection type in question, voltage, effective voltage value, frequency, phase shift. The grid characteristic values can be stored in the data memory for example in the form of a table or in a relational database, with the assigned distribution grid being assigned to a respective set of grid characteristic values, for example by a distribution grid identifier. Operational specifications for the corresponding distribution grid can then in turn be assigned to the distribution grid identifier. It is also possible for the operational specifications for a distribution grid to be directly assigned to the grid characteristic values for this distribution grid.

By providing a data memory with stored grid characteristic values for different distribution grids, the charging station can be configured such that a transnational or, if applicable, even practically worldwide use of the charging station is possible since the configuration of the charging station can adapt itself to the respective distribution grid.

In a further embodiment, the control device is configured to carry out the identification of the distribution grid connected to the grid-side multi-wire power connection upon commissioning and/or after a restart. In a corresponding embodiment of the method, the connected distribution grid is identified upon commissioning and/or after a restart of the charging station. In this manner, the charging station configures itself automatically once after its installation in a distribution grid or after a restart, for example after maintenance, an update or upgrade of the charging station, without the installer having to carry out a manual configuration.

In a further embodiment, the control device is configured to cause the control of the charging station according to the previously described method or of an embodiment thereof. To this end, the charging station can in particular have a data memory with commands, whose execution on at least one processor of the control device causes the previously described method to be carried out.

### BRIEF DESCRIPTION OF THE DRAWINGS

Further advantages and features of the charging station described here and the method described here emerge from the following description of exemplary embodiments, with reference being made to the enclosed drawing, in which is shown:

FIG. 1 an exemplary embodiment of the charging station for providing electrical power to charge an electrically operable vehicle in a schematic view,

FIG. 2a-c different connection possibilities of distribution grids to the charging station from FIG. 1 and

FIG. 3 an exemplary embodiment of the method according to the invention for controlling the charging station from FIG. 1.

### DETAILED DESCRIPTION

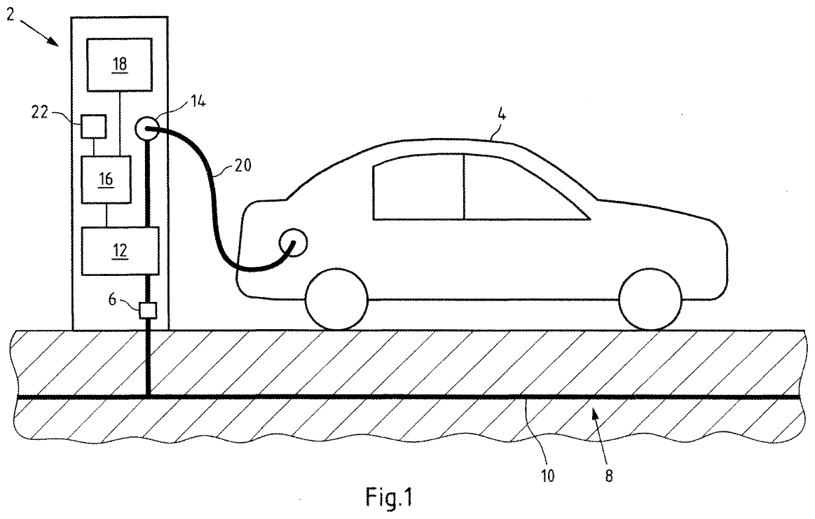

FIG. 1 shows a charging station 2 in the form of a charging pole for providing electrical power to charge an electrically operable vehicle 4. To this end, the charging station 2 has a grid-side multi-wire power connection 6 with which the charging station 2 is connected to a local distribution grid 8, of which an underground cable 10 is represented schematically in FIG. 1.

The multi-wire power connection 6 is coupled to a charging station electronics 12, which has the components required for providing a charging current via the charging outlet 14 connected to the charging station electronics 12, in particular rectifiers, transformers, etc. Furthermore, the charging station electronics 12 can have measuring electronics in order to detect the characteristic variables of a charging process, in particular the total energy and/or the charging power discharged during the charging process to the vehicle 4 to be charged.

The charging station electronics 12 is controlled by means of a control device 16, which is represented in FIG. 1 as a separate unit, but can also be formed integrally with the charging station electronics 12. The control device 16 also controls a user interface 18 provided on the charging pole 2, represented in FIG. 1 by way of example in the form of a touchscreen, via which information for the user can be output or user inputs received.

For example, the control device 16 can be configured, upon receipt of a corresponding user input via the user interface 18, to cause the charging station electronics 12 to start a charging process and to supply the charging outlet 14 with a charging current. In this manner, a user can connect their vehicle 4 using a charging cable 20 to the charging outlet 14 and start a charging process via a user input on the touchscreen 18.

The charging station 2 also has a data memory 22. The data memory 22 can for example be a RAM or a ROM memory. Programs can be stored on the data memory 22, whose execution on a processor of the control device 16 causes the control of the charging station 2, for example the carrying out of a charging process.

In different distribution grids, in particular in different countries, there are different operational specifications for the operation of a charging station, for which the charging station has to be configured. The operational specifications affect in particular grid specifications such as a maximum power that is to be extracted from the distribution grid or also charging process-related specifications, such as for example current strength to be provided via the charging outlet 14 or even other specifications such as information to be displayed via the user interface or the language of the information.

The charging station 2 must be set to the specifications applicable in the distribution grid 8 in question in order to be operated.

In the past, it was necessary to equip the charging station 2 specifically for the respective distribution grid in which the charging station was intended to be used. This resulted in a separate charging pole type having to be manufactured practically for each country or to some extent even different charging pole types when different distribution grids with different operational specifications are used in the country.

The charging station 2 can in contrast be used in different distribution grids since the charging station 2 can configure itself as a function of the respective distribution grid.

To this end, the control device 16 is configured to identify a distribution grid 8 connected to the grid-side multi-wire power connection 6 by means of a grid analysis at the multi-wire power connection 8 and to configure the charging station as a function of the identified distribution grid. Such a grid identification and automatic configuration of the charging pole 2 preferably takes place automatically upon first commissioning of the charging pole or upon a restart of the charging pole, for example after maintenance. In this manner, the charging pole 2 automatically detects in which distribution grid 8 the charging pole 2 is installed and configures itself accordingly such that the specifications of the distribution grid 8 in question are met.

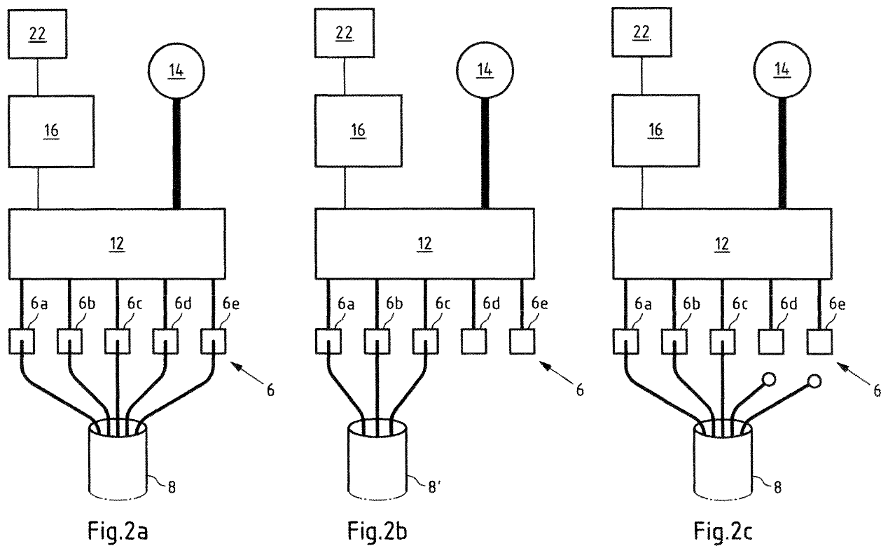

FIGS. 2a-c show by way of example a few connection possibilities of distribution grids to the charging station 2 from FIG. 1. The multi-wire power connection 6 has in total five connections 6a-e. In this manner, the majority of the distribution grids used worldwide can be connected to the multi-wire power connection 6.

FIG. 2a shows the connection of a three-phase rotary current with five wires of the European distribution grid. In this example, the three phases L1 to L3 are connected to the connections 6a-c, the neutral wire N is connected to the connection 6d and the protective wire PE to the connection 6e.

FIG. 2b shows the connection of a three-wire rotary current distribution grid 8′ from the USA to the multi-wire power connection 6 of the charging station 2. In this example, the wires of the three phases of the distribution grid 8′ are connected to the first three connections 6a-c of the multi-wire power connection 6, while the connections 6d-e remain free.

Different distribution grids also enable different connection types such that a distribution grid can be connected to the multi-wire power connection 6 in different manners. As an example, FIG. 2c shows a single-phase connection type of the European three-phase rotary current grid 8. In this connection type, only three connections 6a-c of the multi-wire power connection 6 are connected, namely to one phase (e.g. L1), to the neutral wire N and to the protective wire PE. The other phases (here: L2, L3) are not connected to the charging pole.

The control device is now configured to identify, by means of a grid analysis, the distribution grid (e.g. 8 or 8′) connected to the grid-side multi-wire power connection 6. To this end, the charging station electronics 12 has measuring circuits in order to measure characteristic values of the distribution grid connected to the multi-wire power connection 6, in particular the number of connected connections (e.g. the number of connected wires), the number of connected phases, the grid frequency, the voltages of the individual connections to one another etc. The control device 16 is also configured to compare the measured electrical characteristic values with predefined grid characteristic values and, as a result, to identify the connected distribution grid.

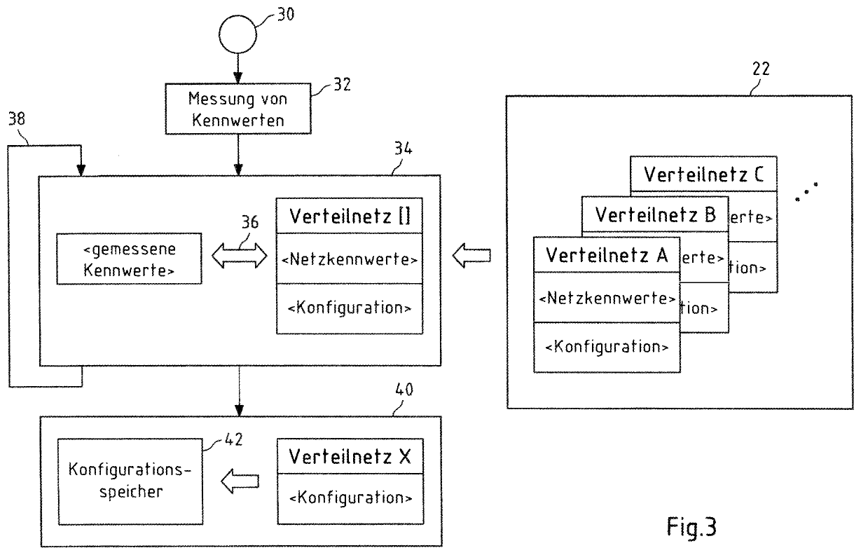

An exemplary embodiment of this process is explained in detail below in connection with FIG. 3.

Starting point 30 of the method shown in FIG. 3 can for example be the initial commissioning of the charging pole 2 or a restart of the software of the control device 16 of the charging pole 2. Alternatively, it is also conceivable that the installer can start the method via a user input, for example via the user interface 18.

In a first step 32 of the method, the control device 16 causes grid characteristic values of the distribution grid 8, 8′ connected to the multi-wire power connection 6 to be measured. In the next step 34, the control device 16 compares the measured grid characteristic values with predefined grid characteristic values. To this end, the control device 16 loads from the data memory 22 a data set stored there of a first distribution grid (e.g. the data set “distribution grid A”), which contains grid characteristic values assigned to the first distribution grid. The control device compares these grid characteristic values with the previously measured characteristic values. If the grid characteristic values match, the distribution grid connected to the multi-wire power connection 6 is then identified as the distribution grid of the corresponding data set. Otherwise, the step 34 is repeated (illustrated in FIG. 3 by the arrow 38) with a data set loaded from the data memory 22 for a next distribution grid (e.g. the data set “distribution grid B”). (The data set loaded for a step 34 in each case from the memory is symbolized in FIG. 3 generally by the data set placeholder “distribution grid [ ]”.)

Alternatively to this successive comparison with grid characteristic values of different distribution grids, the measured characteristic values can also be compared in a step with predefined grid characteristic values of different distribution grids in order to identify the distribution grid connected to the multi-wire power connection 6 as the distribution grid, whose assigned grid characteristic values best match the measured grid characteristic values.

The following table 1 shows exemplary grid characteristic values of predefined distribution grids and connection types of the distribution grids, with which the measured characteristic values can be compared:

TABLE 1
exemplary grid characteristic values of some distribution grids
and connection types

| | Distribution grid | | | | | |
|---|---|---|---|---|---|---|
| | Europe I | | Europe II | | USA I | USA II |
| Connection | rotary | single- | rotary | single- | rotary | rotary |
| type | current | phase | current | phase | current | current |
| Number of | 5 | 3 | 4 | 2 | 4 | 3 |
| wires | | | | | | |
| Number of | 3 | 1 | 3 | 1 | 3 | 3 |
| phases | | | | | | |
| Grid | 50 Hz | 50 Hz | 50 Hz | 50 Hz | 60 Hz | 60 Hz |
| frequency | | | | | | |
| Voltage | 400 V | −/− | 400 V | −/− | 208 V | 208 V |
| phase-phase | | | | | | |
| Voltage | 230 V | 230 V | 230 V | 230 V | 120 V | 120 V |
| phase-zero | | | | | | |

By comparing the measured grid characteristic values with the predefined grid characteristic values, the control device 16 can for example distinguish between the distribution grids 8 and 8′ connected in FIGS. 2a-c.

In the above exemplary connections in FIG. 2a-c, FIG. 2a for example corresponds to the distribution grid “Europe I” with connection type “rotary current”, FIG. 2b corresponds to the distribution grid “USA II” with connection type “rotary current” and FIG. 2c corresponds to the distribution grid “Europe I” with connection type “single-phase”. Through the grid analysis of the respective distribution grid connected to the multi-wire power connection 6, in particular by determining or measuring the grid characteristic values indicated in the first column of Table 1 and possible further grid characteristic values and comparing the determined or measured grid characteristic values with the grid characteristic values of different distribution grids and connection types predefined in Table 1, the control device 16 can determine the distribution grid connected to the multi-wire power connection 6 as one of distribution grids listed in Table 1.

The grid analysis of the exemplary connection in FIG. 2a for example results in the following grid characteristic values:
Number of lines=5
Number of phases=3
Grid frequency=50 Hz
Voltage phase-phase=400 V
Voltage phase-zero=230 V

By comparing these grid characteristic values with the predefined grid characteristic values from Table 1, the control device 16 can determine that it is connected to the distribution grid “Europe I” with connection type “rotary current” in the case of FIG. 2a.

After identifying the distribution grid connected to the multi-wire power connection 6, the control device 16 loads in step 40, if not already carried out beforehand, e.g. in step 34, the operational specifications (symbolized in FIG. 3 in each case by the data set field “<configuration>”) assigned to the identified distribution grid (in FIG. 3: “distribution grid X”) from the data memory 22 and configures the charging station 2 accordingly, for example by setting predefined variables in a configuration memory 42, which is accessed during the control of the charging station 2, for example before or during the carrying out of a charging process.

The operational specifications, with which the control device 16 configures the charging station 2 as a function of the identified distribution grid, can for example comprise grid specifications, charging process specifications and/or other specifications.

Examples of grid specifications are specifications for the maximum current strength, for the maximum power extraction, for the maximum reactive power. Examples of charging process specifications are specifications for the minimum and/or maximum charging current, specifications for the minimum and/or maximum charging voltage.

In this manner, the charging station 2 can configure itself as a function of the distribution grid, to which the charging station 2 is connected and, as a result, automatically meets the operational specifications applicable in this distribution grid.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A charging station for providing electrical power to charge an electrically operable vehicle, comprising a grid-side multi-wire power connection for connecting the charging station to a distribution grid and comprising a control device for controlling the charging station, wherein the control device is configured to identify, by means of a grid analysis, a distribution grid connected to the grid-side multi-wire power connection.

2. The charging station according to claim 1, wherein the control device is configured to control, in particular to configure, the charging station as a function of the identified distribution grid.

3. The charging station according to claim 2, wherein the configuration of the charging station comprises the setting of operational specifications to operate the charging station, in particular grid-related and/or charging process-related operational specifications, as a function of the identified distribution grid.

4. The charging station according to claim 1, wherein the control device is configured to cause, for the grid analysis, the determination, in particular the measurement, of one or a plurality of electrical characteristic values of the distribution grid connected to the grid-side multi-wire power connection.

5. The charging station according to claim 1, wherein the control device is configured, for the identification of the distribution grid connected to the grid-side multi-wire power connection, to compare the determined electrical characteristic values wire with predefined grid characteristic values.

6. The charging station according to claim 1, wherein
respective grid characteristic values for a plurality of predefined distribution grids are stored on a data memory of the charging station and
the control device is configured to compare the determined electrical characteristic values with the stored grid characteristic values and to identify the distribution grid connected to the grid-side multi-wire power connection as a function of the result of the comparison as one of the plurality of predefined distribution grids.

7. The charging station according to claim 1, wherein
the control device is configured to carry out the identification of the distribution grid connected to the grid-side multi-wire power connection upon commissioning and/or after a restart.

8. The charging station according to claim 1, wherein the control device is configured to cause the control of the charging station according to a method
in which a grid analysis of a distribution grid connected to the grid-side multi-wire power connection of the charging station is carried out and
in which the connected distribution grid is identified on the basis of the grid analysis.

9. A method for controlling a charging station according to claim 1,
in which a grid analysis of a distribution grid connected to the grid-side multi-wire power connection of the charging station is carried out and
in which the connected distribution grid is identified on the basis of the grid analysis.

10. The method according to claim 9, wherein the charging station is controlled, in particular configured, as a function of the identified distribution grid.

11. The method according to claim 10, wherein, when configuring the charging station, operational specifications for operating the charging station, in particular grid-related and/or charging process-related operational specifications, are set as a function of the identified distribution grid.

12. The method according to claim 9, wherein for the grid analysis, one or a plurality of electrical characteristic values of the distribution grid connected to the grid-side multi-wire power connection are determined, in particular measured.

13. The method according to claim 9, wherein for identifying the distribution grid connected to the grid-side multi-wire power connection, the determined electrical characteristic values are compared with predefined grid characteristic values.

14. The method according to claim 9, wherein
respective grid characteristic values for a plurality of predefined distribution grids are stored on a data memory of the charging station and
the determined electrical characteristic values are compared with the stored grid characteristic values and the distribution grid connected to the grid-side multi-wire power connection is identified as one of the plurality of predefined distribution grids as a function of the result of the comparison.

15. The method according to claim 9, wherein the connected distribution grid is identified upon commissioning and/or after a restart of the charging station.
